(19) United States
(12) Patent Application Publication
(10) Pub. No.: US 2023/0019095 A1
(43) Pub. Date: Jan. 19, 2023

(54) METHOD FOR PRODUCING SUPERSULPHATED CEMENT

(71) Applicant: GREENMADE, Chatou (FR)

(72) Inventor: Edouard Dumoulin, Nice (FR)

(73) Assignee: GREENMADE, Chatou (FR)

(21) Appl. No.: 17/757,487

(22) PCT Filed: Dec. 18, 2020
(86) PCT No.: PCT/EP2020/087276

§ 371 Date: Jun. 16, 2022

(30) Foreign Application Priority Data
Dec. 20, 2019 (FR) FR1915293

(51) Int. Cl. C04B 7/12; C04B 28/06; C04B 7/14; C04B 18/28

(52) U.S. Cl. CPC C04B 7/12; C04B 28/065; C04B 7/14; C04B 18/28; C04B 2111/23

(57) ABSTRACT

The invention relates to a method for producing supersulfated cement, wherein pozzolanic and hydraulic aluminosilicate components and a calcium-sulfate-alkaline activation complex are mixed together. The calcium-sulfate-alkaline activation complex is produced by carrying out the following successive steps: a first step of mixing 70% by weight of calcium sulfate and 30% by weight of alkaline components; and subsequently; a second step of thermodynamically activating, by hot quenching, the calcium-sulfate-alkaline activation complex; and subsequently; a third step of cold quenching, by rapid mixing, the activated calcium-sulfate-alkaline activation complex with the pozzolanic aluminosilicate components.

### CROSS REFERENCE TO RELATED APPLICATION

This application is a national stage entry of PCT/EP2020/087276 filed Dec. 18, 2020, under the International Convention and claiming priority over French Patent Application No. FR1915293 filed Dec. 20, 2019.

### TECHNICAL FIELD

The invention relates to the technical field of the cement industry, and more particularly to supersulphated cements, in other words cements with a high sulfate content. The invention relates in particular to a method for producing a supersulphated cement, the supersulphated cements obtained by said method, and their use for the preparation of materials such as concrete, mortar or grout and the admixture of cements in order to improve their performances.

### BACKGROUND OF THE INVENTION

A cement is a hydraulic binder which hardens under the action of water, used in the preparation of concrete and most mortars. It is a hydraulic pulverulent material, in other words a very fine and very reactive powder. When this powder is mixed with water, it forms a paste which hardens due to hydration reactions. After hardening, this mixture retains its strength and stability even under water.

Cements are currently classified according to their clinker content and other components (lime, silica fumes, pozzolan, blast-furnace slag, etc.).

Traditionally, the method for producing a Portland type cement comprises the following steps:

i. firing at high temperature (about 1450° C.) in a rotary kiln, a dosed mixture of limestone (about 80% by weight) and clay (about 20% by weight), to produce what is called cement clinker; and

ii. co-grinding the cement clinker obtained with gypsum to obtain a very fine and very reactive powder.

However, the firing step (i) performed to produce cement clinker, a key ingredient of cement, is extremely energy-consuming and emits large quantities of CO₂. During this firing step, the limestone (CaCO₃) undergoes decarbonation into carbon dioxide (CO₂) and free lime (CaO) according to the following reaction:

CaCO3(s)→CaO (s)+CO₂ (g)

It is generally considered that the production of one metric ton of cement clinker is accompanied by the production of about 0.85 metric tons of CO₂ resulting from the “decarbonation” as such for 0.55 metric tons, and from the energy expenditure for firing and grinding for 0.3 metric tons of CO₂.

We observe a constant increase in CO₂ in the atmosphere which results in global warming due to the greenhouse gas effect. It is therefore easy to understand that cement manufacturers are constantly striving to reduce CO₂ emissions.

To overcome this environmental problem, it is known to use aluminosilicate components such as blast-furnace slag and fly ashes, but not exclusively, to reduce the proportion of cement clinker used to produce cement. This technique offers the advantage of allowing both a reduction in CO₂ emissions per metric ton of cement produced and reducing the consumption of non-renewable natural raw materials, such as limestone and/or clay.

However, the major disadvantage of this technique is that it produces cements exhibiting poor mechanical performances at young age, in other words less than 7 days old, and high drying shrinkage requiring preventive curing.

The use of supersulphated cement is also known. A supersulphated cement is one composed mainly (standard NF EN 15743) of blast-furnace slag (S) and calcium sulfates (Cs). The proportion by weight of the slag (S) is at least 75%, and the proportion by weight of calcium sulfates (Cs) is between 5% and 20%. The proportion by weight of clinker (K) varies from 0% to 5%. Other secondary constituents (A) may be present, in a proportion by weight varying from 0% to 5%, and finally additives may be added in a proportion by weight of less than 1%.

The state of the art, in particular document WO2015104466A1, already describes a method for preparing such a cement, based on clinker or lime, calcium sulfate in the form of soluble anhydrite, and pozzolanic and hydraulic components. This method comprises the following steps:

i. heat treating a pulverulent mixture comprising cement or cement clinker or lime, and calcium sulfate, at a temperature of between 200° C. and 800° C., to form a pulverulent composite product comprising cement or cement clinker or lime, combined with calcium sulfate in the form of soluble anhydrite; and

ii. cooling the particles of said composite product by bringing into contact with a pulverulent pozzolanic component, to reduce the temperature of said particles to less than 45° C. in less than two minutes, and to obtain said hydraulic cement in the form of pulverulent powder.

### OBJECTS AND SUMMARY OF THE INVENTION

A technical problem that the invention seeks to solve is to improve this type of method:

regarding the mechanical requirements in terms of short-term strength, i.e. obtaining increased strength from the first hours of setting;

regarding the physical requirements in terms of setting onset time, stability, and heat of hydration;

regarding the environmental requirements: reduction of the environmental impact of the method by reducing the production energy requirements and optimization of the cement components (requirements in terms of loss on ignition, insoluble residues, sulfate content, and chloride content in particular).

To this end, the invention relates to a method for producing supersulphated cement, wherein pozzolanic and hydraulic aluminosilicate components and a calcium-sulfate-alkaline activation complex ((Cs)+(K)+(A)) are mixed together, wherein said calcium-sulfate-alkaline activation complex is produced by carrying out the following successive steps:

a first step of mixing 70% by weight of calcium sulfate and 30% by weight of alkaline components; and subsequently

a second step of thermodynamically activating, by hot quenching, said calcium-sulfate-alkaline activation complex; and subsequently

a third step of cold quenching, by rapid mixing, the activated calcium-sulfate-alkaline activation complex with the pozzolanic and hydraulic aluminosilicate components.

Said calcium-sulfate-alkaline activation complex thus produced is used to increase the formation of the stable primary ettringite, and to increase the kinetics of formation of calcium silicate hydrates (CSH) during its hydration in the presence of pozzolanic and hydraulic aluminosilicate components.

The flash thermodynamic treatment applied simultaneously to the premixed activation components (Cs)+(K)+(A) improves their solubility and their hydraulic and chemical reactivity during their hydration in the presence of the aluminosilicate components.

In the third step 3, all the components (pozzolanic and hydraulic aluminosilicates) are mixed with a calcium-sulfate-alkaline activation complex, the crystalline structure of the composite product is frozen and stabilized, and the metastability of the product in the open air is reduced. The particle size of the pulverulent composition is between 5 microns and 100 microns and its specific surface area is greater than 12 m²/g.

Since the hydraulic reactivity of the activation complex is very high, the clinker or the Portland cement can be eliminated, if necessary, in the production of supersulphated cement resulting from the method according to the invention.

Moreover, the mechanical performances of the supersulphated cement thus obtained are 15% to 25% higher compared with the state of the art, in particular from the first hours of setting.

The initial setting time is also increased.

The mortars and concretes are more fluid due to the crystalline morphologies of rounded shape.

Finally, the energy consumption has been reduced by 50% compared with a supersulphated cement of the prior art, by reducing the calcination temperatures, partially recycling the hot calcination air, and heating the new air in a heat exchanger recovering the thermal effluents from the extracted air.

The method may further comprise one or more of the following characteristics, taken alone or in combination:

calcium sulfate is a composition comprising 5% to 10% by weight of soluble anhydrite II, 70% to 80% by weight of alpha anhydrite III, and 15% to 30% by weight of alpha hemihydrate produced in pressurized superheated steam;

the alkaline components are selected alone or in combination from the following components: synthetic or natural pozzolanic and hydraulic components, an amorphous calcium aluminate, hydraulic limes, calcic limes, quicklimes, basic components;

the pozzolanic and hydraulic aluminosilicate component comprises at least 75% by weight of natural (in particular of volcanic origin) or synthetic (in particular of blast-furnace origin) pozzolanic components;

the pozzolanic and hydraulic aluminosilicate components comprise a granulated blast-furnace slag (but not exclusively);

at least 75% by weight of pozzolanic and hydraulic aluminosilicate components are mixed with a maximum of 30% by weight of the calcium-sulfate-alkaline activation complex;

the second step of activating said calcium-sulfate-alkaline activation complex comprises transforming and activating the calcium sulfate using a flash thermodynamic method;

the flash thermodynamic method is adapted to homogenize, micronize, thermally shock said calcium sulfate, and transform it into phases with high hydraulic reactivities, such as anhydrite II, beta anhydrite III, and alpha hemihydrate composite phases (the latter phase is produced under pressurized superheated steam in controlled atmosphere) combined concentrically within the same particles.

micronization is a kinetic autogenous micronization obtained by mechanosynthesis of particles in the flash thermodynamic method;

the temperature of the components of the calcium-sulfate-alkaline activation complex is between 150° C. and 300° C. at the outlet of the flash thermodynamic method;

the flash thermodynamic method comprises a step of thermal shock carried out in a hot fluid of superheated steam;

the transformation of calcium sulfate is a transformation in complex phases carried out by a flash thermodynamic reactor comprising a toroidal duct of variable cross-section and an electronic management unit;

the electronic management unit is designed to control the parameters of the thermal activation step:

a step of almost instantaneously dehydrating the components of the calcium-sulfate-alkaline activation complex is carried out by direct contact and by entrainment by a gaseous fluid loaded with superheated steam in the toroidal duct placed under reduced pressure at the outlet and subjected at the inlet to a pressure of between 50 mbar and 200 mbar, at a temperature set between 250° C. and 450° C., generating a flow of the gaseous fluid entering at a speed of between 15 m/s and 25 m/s; this step increases by 50% the reactivities and the mechanical performances of the cement at young and old age (compression strengths of up to 25 MPa at 48 hours and 70 MPa at 28 days) compared with the conventional calcination methods which do not exceed 12 MPa at 48 hours and 49 MPa at 28 days; at the same time, an autogenous micronization of very high Blaine fineness greater than 12 m²/g is achieved;

the hot fluid loaded with superheated steam is partially recycled and mixed with the new air in an electro-regulated mixing chamber; thus, the energy consumption is reduced by recycling the hot air, thereby significantly improving the thermal balance and the thermal transfer of the hot fluid loaded with superheated steam in contact with the particles of the activation complex. Their dehydration is accelerated, thereby intensifying their hydraulic reactivity;

the new air is heated by the hot fluid extracted in an air/air heat exchanger;

the fluid loaded with steam is heated by an automated burner (gas, coal, fuel oil) and mixed in a combustion chamber before being injected into the flash thermodynamic reactor by a battery of injectors; recycling the hot air at the outlet of the flash thermodynamic method considerably reduces, by up to 40%, the consumption of the burner which regulates the hot fluid injection temperature;

at the outlet of the flash thermodynamic reactor, the speed of the hot gaseous fluid is between 30 m/s and 40 m/s, the temperature is between 180° C. and 300° C.;

the third step of cold quenching is carried out to cool the calcium-sulfate-alkaline activation complex to a temperature of between 30° C. and 50° C. in less than one minute;

the third step of cold quenching is carried out by rapidly mixing the activated calcium-sulfate-alkaline activation complex at the outlet of the flash thermodynamic method with pulverulent aluminosilicate components at 30° C.+/−15° C. in a continuous mixer;

the third step of cold quenching is carried out by rapidly mixing the calcium-sulfate-alkaline activation complex at the outlet of the flash with the pozzolanic aluminosilicate components, for example ground blast-furnace slags, at ambient temperature (but not exclusively).

The invention also relates to a supersulphated cement obtained by the method according to the invention.

The invention also relates to uses of a cement according to the invention for its implementation:

in the production of low heat of hydration, sea setting, sulfate-resistant and acid-resistant concretes and in the production of technical mortars; or

in the production of cast or molded cellular concrete hardened under atmospheric pressure, comprising said cement, mixing water, at least one surfactant, at least one fluidizing agent, and optionally at least one foaming agent; or

in the composition of a hydraulic road binder (HRB) with normal or rapid hardening; or

in the production of a calcium-sulfate-alkaline activator to improve the performances of cements, concretes and mortars; or

to improve the performances of cements, concretes, technical mortars, slag cements, aluminous cements, sulfoaluminous cements and geotechnical or road binders, plasters, hydraulic or calcic limes; or

for the production of sand concrete based on aggregates of round eolian sands, or dune sand, eolian sands or ordinary sand; or

for the production of lightweight aggregates, thermal and acoustic insulation based on plant or wood waste or ground straw or other low-density waste, by mineralization of these components by means of a coating with quick-setting grout based on said cement; or

for the production of thermally-activated concretes; or

for the production of plaster components of very high shore hardness implemented by molding, casting, injection, spraying, lamination; or

for the encapsulation of hazardous industrial waste by coating these components in a stable and non-leachable mineral matrix; or

for the production of prefabricated composite elements based on wood and concrete, elements such as panels, sandwich panels, insulating panels, acoustic panels, slabs, preslabs, walls.

### BRIEF DESCRIPTION OF THE FIGURES

The invention will be better understood on reading the following description, given solely by way of example and with reference to the accompanying drawings in which:

FIG. 1 is a diagrammatic view of an installation used to implement the method for producing supersulphated cement according to the invention;

FIG. 2 is a graph used to compare the increase in strength against the number of days hydration of the supersulphated cements in the state of the art in red, firstly, with SSCs according to this invention, secondly; and

FIG. 3 is used to compare the CO2 emissions of various types of cement depending on the production method, in particular the SSCs according to this invention whose emission level is represented by the SSC bar on the abscissa.

### DETAILED DESCRIPTION OF THE INVENTION

The invention relates to a method for producing supersulphated cement, wherein pozzolanic and hydraulic aluminosilicate components and a calcium-sulfate-alkaline activation complex (Cs)+(K)+(A) are mixed.

The supersulphated cement thus obtained comprises a mixture of a maximum of 30%, preferably between 5% and 20%, by weight of the calcium-sulfate-alkaline activation complex, and at least 75% by weight of pozzolanic and hydraulic aluminosilicate components (S).

The synthetic (in particular of blast-furnace origin) or natural (in particular of volcanic origin) pozzolanic and hydraulic aluminosilicate components have a high pozzolanic index (according to a Chapelle test) and a high hydraulic activity in the presence of the calcium-sulfate-alkaline activation complex.

According to one example, the pozzolanic and hydraulic aluminosilicate components comprise a granulated blast-furnace slag, but not exclusively.

According to the invention, the calcium-sulfate-alkaline activation complex is produced by carrying out the following successive steps:

a first step of mixing 70% by weight of calcium sulfate and 30% by weight of alkaline components; and subsequently

a second step of thermodynamically activating, by hot quenching (toroid flash method) said calcium-sulfate-alkaline activation complex; and subsequently

a third step of cold quenching, by rapid mixing, the activated calcium-sulfate-alkaline activation complex with the pozzolanic aluminosilicate components.

The mechanisms for activating and hydrating the pozzolanic and hydraulic aluminosilicate components (S) are as follows:

1. The calcium-sulfate-alkaline activation complex comprises activators acting as alkaline catalysts which trigger a “hydroxylic” attack, which increases the dissolution, precipitation and crystallization reactions of the vitreous components SiO2 of the pozzolanic and hydraulic aluminosilicates and of the calcium components CaO, these catalysts not being included in the structure of the hydrates. These reactions in alkaline medium increase the solubility of the siliceous and calcareous components. Hydrates can only be formed in a highly basic medium, which prevents the formation of an alumina gel blocking further hydration of the aluminosilicate components into calcium silicate hydrate (CSH). Dissolution is only possible when the pH of the medium exceeds about 12.5, determined by the calcium hydroxide dissolution-precipitation equilibrium (pH=12.5 to 12.6). In turn, this precipitation lowers the concentration of the elements in the solution, allowing a new quantity of product to dissolve until hydrated compounds precipitate again. The Si₄O₂ and Al₃O₂ tetrahedra composing the vitreous phases of the pozzolanic material are separated and release SiO(OH)₃ and Al(OH)₄ ions, thereby increasing the density of the calcium silicate hydrates (CSH).

2. The activation complex also comprises reactants, mainly sulfate, aluminous and calcic components, which increase the numerous dissolution, precipitation, substitution and crystallization chemical reactions of the calcic and aluminous elements, which lead to the formation of the hydrates and in particular the stable primary ettringite. As an indication, the thermodynamically activated calcium sulfate in the flash thermodynamic method according to the invention (step 2) is 50% more soluble and more reactive than the calcium sulfate dihydrate or hemihydrate or anhydrite.

First Step: Mixing the Components of the Activation Complex

According to this invention, the calcium-sulfate-alkaline activation complex is composed of:

70% calcium sulfate, natural or synthetic, comprising 5% to 10% by weight of soluble anhydrite II, 70% to 80% by weight of beta anhydrite III, and 15% to 30% by weight of alpha hemihydrate

30% alkaline components (sodium carbonate, sodium silicate, sodium hydroxide, sodium sulfate, lime, Portland cement or sulfoaluminous cement, aluminous cement, etc.).

In particular, the calcium-sulfate-alkaline activation complex is composed of calcium sulfate (Cs), secondary activation constituents (A), additives (setting, rheology and alkaline pH regulators), and optionally of clinker (K) or cement, but preferably without clinker (K) or cement.

The alkaline components are selected alone or in combination from the following components: synthetic or natural pozzolanic components (such as conventional cements or aluminous cements or sulfoaluminous cements), an amorphous calcium aluminate, hydraulic limes, calcic limes, quicklimes, basic components (such as sodium carbonate or calcium silicate or potassium hydroxide, or lithium carbonate).

In the calcium-sulfate-alkaline activation complex, the components are previously dosed and mixed with the calcium sulfate component (Cs) before their flash thermodynamic treatment (second step).

Generally, the components of the activation complex are perfectly mixed and homogenized before their flash thermodynamic treatment (second step).

This improved chemical composition increases the formation of the stable primary ettringite, and increases the kinetics of formation of the calcium silicate hydrates (CSH).

The composition of the mixture of pozzolanic and hydraulic aluminosilicate components (S) and of the calcium-sulfate-alkaline activation complex is described in detail below.

a) Pozzolanic and hydraulic aluminosilicate components

Advantageously, the pozzolanic and hydraulic aluminosilicate components are a ground blast-furnace slag (GBS) dosed to at least 75% by weight.

According to another example, the pozzolanic and hydraulic aluminosilicate components are aluminosilicate components with high pozzolanicity and hydraulicity of natural or synthetic origin, in particular selected alone or in combination, from the following products: converter steelworks slags, silico-manganese slags, calcined clays, natural pozzolans, volcanic tuffs, metakaolins but not exclusively.

Due to the improved chemical and hydraulic reactivities induced by the calcium-sulfate-alkaline chemical activation complex ((Cs)+(K)+(A)) according to this invention, there is a wider choice, compared with the cements known in the prior art, of synthetic or natural alumino-silicate pozzolanic components which can be used as a substitute for ground slags and which can be included in the composition of new supersulphated cements complying with the applicable standards. These components with high latent hydraulicity also exhibit high pozzolanicity indices or Chapelle activity index [NF P 18-513]. These substitution components include two-thirds by weight of the sum of calcium oxide (CaO), magnesium oxide (MgO) and silicon dioxide (SiCO₂). The rest contains aluminum oxide (Al₂O₃) and small quantities of other components.

Preferably, the weight ratio (CaO+MgO)/(SiO₂) is greater than 1. The choice of aluminosilicate substitution components does not affect the performances of the supersulphated cements as required by standard 15743.

Thus, the pozzolanic and hydraulic aluminosilicate components (S) are selected alone or in combination from the following components: natural pozzolans, volcanic tuffs, blast-furnace slags (S) mixed with converter steelworks slag (CSS), calcined clays, calcined red muds, silico-aluminous ashes, paper mill ashes, fly ashes, metakaolins, calcined shales, sediments and all mixtures of said components.

b) K components of the calcium-sulfate-alkaline activation complex (Cs+K+A)

According to one example, this component is a cement or ground clinker or preferably a CEM 1 52.5 cement. Portland clinker is obtained by sintering a precise mixture containing elements, generally in the form of oxides, CaO, SiO₂, Al₂O₃, Fe₂O₃ and small quantities of other materials. Portland clinker is a hydraulic material which must contain at least two thirds by weight of calcium silicates (3CaO.SiO2 and 2CaO.SiO2), the remainder consisting of clinker phases containing aluminum, iron and other components. The ratio (CaO)/(SiO2) is not less than 2.0. The magnesium oxide (MgO) content does not exceed 5.0% by weight. It is important to reduce or preferably eliminate the cement or ground clinker to reduce the environmental impact of the supersulphated cement.

Elimination is made possible due to the higher hydraulic and chemical reactivities of the activation complex.

Thus, preferably, the calcium-sulfate-alkaline activation complex (Cs+K+A) has no K component.

c) A components of the calcium-sulfate-alkaline activation complex (Cs+K+A)

Advantageously, this component is a secondary constituent comprising calcium hydroxide, obtained from industrial processes, specially selected mineral components, of natural origin and/or derived from specified industrial processes.

The source of calcium hydroxide is slaked lime, calcic lime, hydraulic lime, or quicklime, or is selected from commercial limes.

This component can also be selected from: components with high pozzolanic reactivity such as flashed metakaolin, non-crystallized amorphous calcium aluminate (ACA), highly basic components such as sodium carbonate, or sodium silicate or potassium hydroxide, or non-crystallized lithium carbonate, or an aluminous cement, or a sulfoaluminous cement or a mixture of said components.

d) Additives of the calcium-sulfate-alkaline activation complex (Cs+K+A)

The additives of the calcium-sulfate-alkaline activation complex can be selected from the following additives:

superplasticizers such as Etacryl M made by Coatex® or ONS 2000 made by Tillmann®, to adjust the fluid rheologies while reducing the quantity of mixing water. These fluidizing agents increase the mechanical performances of the supersulphated cements by 10% to 25% by reducing the porosities of the cement matrices thus obtained.

setting retarder additives that delay setting by up to two hours, such as SIKA retarder P, alkaline agents, which increase the pH of the interstitial solutions of pastes such as sodas, sodium carbonates or sodium silicates.

The additives do not exceed a total of 1% by weight of the cement.

e) Additions to the calcium-sulfate-alkaline activation complex (Cs+K+A)

These additions can be mineral fillers of particle size less than 100 microns, preferably less than 50 microns such as: aluminosilicates, siliceous components, lime sands, calcium carbonates, natural or synthetic pozzolans, silica fumes, fly ashes, zeolites, diatoms, magnesium, etc. The additions reduce the water to binder ratio W/B. They significantly improve (by 5% to 15%) the mechanical performances of concretes produced with supersulphated cements.

Second Step: Thermodynamically Activating, by Hot Quenching, the Activation Complex

The second step of activating the calcium-sulfate-alkaline activation complex comprises transforming and activating the calcium sulfate using a flash thermodynamic method.

The activation complex is thermodynamically activated using a flash thermodynamic method at a temperature of between 250° C. and 450° C. to form a pulverulent composite comprising less than 15% of soluble anhydrite II CaSO₄, zero H₂O phases and at least 85% of soluble alpha anhydrite III CaSO₄ zero H2O. The activation complex is calcined in contact with a hot fluid of superheated steam resulting firstly from dehydration of the gypsum and secondly from partial recycling of this hot fluid. The addition of superheated steam obtained by recycling the hot fluid characterizes the nature of the original “Alpha Sigma” sulfate phases thus produced, and whose performances are similar to those of the phases of the Alpha plasters steamed and pressurized in the presence of superheated steam.

These ALPHA SIGMA phases thus obtained are specific to the method according to the invention and are perfectly identifiable by means such as SEM microscopes, DRX diffractometers and by ATD/TG thermal analyses.

The flash thermodynamic method of the method according to the invention is designed to homogenize, micronize, thermally shock said calcium sulfate, and transform it into phases with high hydraulic reactivities such as anhydrite II, beta anhydrite III and beta hemihydrate composite phases. Micronization is a kinetic autogenous micronization obtained by mechanosynthesis of particles, inside an asymmetric toroidal duct of variable cross-section.

The flash thermodynamic method of the method according to the invention comprises a step of thermal shock carried out inside a hot fluid of superheated steam.

In this method, the transformation of calcium sulfate is a transformation in complex phases carried out by a flash thermodynamic reactor comprising a toroidal duct and an electronic management unit. The electronic management unit is designed to control all the parameters of the thermal activation method, i.e. an inlet temperature and an outlet temperature of the flash thermodynamic reactor, a cold quenching temperature, a dosage of the various components of said supersulphated cement, atmospheric pressures upstream and downstream from the flash thermodynamic reactor, speeds of the hot fluid upstream and downstream from the flash thermodynamic reactor, air flow rates at the outlet of the flash thermodynamic reactor.

Preferably, a step of almost instantaneously dehydrating the components of the calcium-sulfate-alkaline activation complex (components introduced in pulverulent or granular form) is carried out by direct contact and by entrainment by a gaseous fluid loaded with superheated steam in the toroidal duct placed under reduced pressure at the outlet and subjected at the inlet to a pressure of between 50 mbar and 200 mbar, at a temperature set between 250° C. and 450° C., generating a flow of the incoming gaseous fluid at a speed of between 15 m/s and 25 m/s.

The hot fluid loaded with superheated steam is partially recycled and mixed with the new air in a mixing chamber, in particular electro-regulated.

The new air is heated by the hot fluid extracted in an air/air heat exchanger.

The fluid loaded with steam is heated by an automated burner (gas, coal, fuel oil) and mixed in a combustion chamber before being injected into the flash thermodynamic reactor by a battery of injectors.

Lastly, at the outlet of the flash thermodynamic reactor, the speed of the hot gaseous fluid is between 30 m/s and 40 m/s, the temperature is between 180° C. and 300° C.

We will now describe an embodiment of the flash thermodynamic method.

According to the invention, the calcium-sulfate-alkaline activation complex (Cs+K+A) is treated after mixing by an improved flash thermodynamic method. This method has the following characteristics:

it comprises a step of almost instantaneously dehydrating the pulverulent or granular components by direct contact and entrainment by a hot gaseous fluid loaded with superheated steam in a flash having a toroidal duct placed under reduced pressure downstream and subjected at the inlet to a pressure of between 50 mbar and 200 mbar upstream;

the temperature of the hot gaseous fluid at the inlet of the flash is set between 250° C. and 450° C.;

the speed of the hot gaseous fluid at the inlet of the flash is between 15 m/s and 25 m/s;

the speed of the hot gaseous fluid at the outlet of the flash is between 30 m/s and 40 m/s;

the pulverulent or granular components undergo autogenous micronization inside the toroidal duct of the flash;

the temperature of the air at the outlet of the flash is between 180° C. and 300° C.; the temperature of the components of the calcium-sulfate-alkaline activation complex is between 100° C. and 200° C. at the outlet of the flash thermodynamic method;

the particle size of the pulverulent composition at the outlet of the flash is between 5 microns and 100 microns and its Blaine specific surface area is greater than 12 m²/g;

the pulverulent composition comprises a rapid cooling step either by contact with cold pulverulent components or by contact in a thin-film heat exchanger;

the hot fluid loaded with superheated steam at the outlet of the flash is partially recycled and mixed with the new air in a mixing chamber;

the new air is heated by the hot air extracted in an air/air heat exchanger;

the hot fluid loaded with superheated steam is heated by an automated burner (gas, coal, fuel oil) and mixed in a combustion chamber; and

the air thus heated is injected into the flash by a battery of injectors.

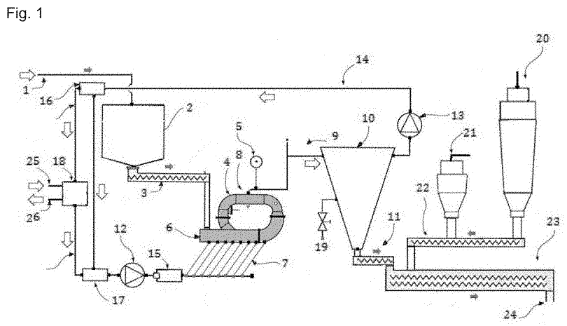

By way of example, FIG. 1 is a diagrammatic view of an installation used to implement the method for producing supersulphated cement according to the invention. The upstream mixer used to combine the components of the activation complex is not shown on this figure. The references of FIG. 1 are as follows:

1: Feeding by a worm screw of the calcium-sulfate-alkaline chemical activation complex previously dosed and mixed

2: Feeder tank hopper for buffer stock of the activation complex

3: Dosing screw to supply the thermodynamic flash with activation complex

4: Toroidal thermodynamic flash with autogenous micronization of the activating components

5: Centralized technical management (CTM) of the flash method

6: Injection tube in the flash of the calcium-sulfate-alkaline chemical activation complex

7: Injectors of hot air loaded with saturated steam

8: Gravimetric selectors at the exit of the particles from the activator

9: Extracted hot air mixed with the pulverulent product

10: Separation of the hot air from the pulverulent finished product

11: Screw extractor at filter outlet

12: Overpressure fan upstream from the flash

13: Pressure fan downstream from the flash

14: Recycling circuit for the hot air loaded with superheated steam

15: Automated fuel oil, gas or coal burner and combustion chamber

16: Dosing chamber for recycling the hot air loaded with superheated steam, using a self-regulated bypass valve

17: Chamber for mixing the air loaded with superheated steam and the heated new air

18: Air/air exchanger to recover energy from the recycled hot air and the new air

19: Dry air compressor and buffer tank to supply the automated filters

20: Crushed aluminosilicate components, ground slags or ground natural pozzolans

21: Cement fillers

22: Screw conveyor and dosage of the pozzolanic components, slags or pozzolans

23: High-speed cooling mixer for the calcium-sulfate-alkaline activation complex and the pozzolanic components

24: Incoming new air

25: Extracted air

100: device to produce the SSC according to the invention

According to one embodiment, the calcium sulfate is injected in the form of hemihydrate or dihydrate, pulverulent or granular, into a flow of hot turbulent air saturated with water vapor, of temperature between 200° C. and 500° C. and speed from 5 m/s to 40 m/s. The hot air flow is firstly composed of a hot air flow loaded with superheated steam obtained by recycling the hot fluid at the flash outlet and secondly of a hot air flow previously heated in contact with the air at the flash outlet in an energy recovery exchanger, said heated air at the outlet of the exchanger being heated to a temperature of 200° C. to 500° C. in a combustion chamber equipped with an automated burner. The mixture of hot air flows is injected into the flash calciner by a battery of injectors. This step is immediately followed by a step consisting in separating the sulfate complex particles thus produced from the hot fluid at the flash outlet in a filter or a cyclone. According to this example, the aluminosilicate components with high pozzolanicity undergo grinding by a vertical mill or a ball mill, have a Blaine specific surface area of 3800 cm²/g to 6000 cm²/g and a grinding fineness of less than 100 microns. The cement thus produced has a Blaine specific surface area of 3800 cm²/g to 6000 cm²/g, and a grinding fineness of less than 100 microns.

Third Step: Cold Quenching

The third step of cold quenching is carried out to cool the calcium-sulfate-alkaline activation complex to a temperature of between 30° C. and 50° C. in less than one minute.

This step of cold quenching is carried out by rapidly mixing the activated calcium-sulfate-alkaline activation complex at the outlet of the flash thermodynamic method with pulverulent aluminosilicate components at 30° C.+/−15° C. in a continuous paddle mixer.

This step of cold quenching is carried out by rapidly mixing the calcium-sulfate-alkaline activation complex at the outlet of the flash thermodynamic method with the pozzolanic aluminosilicate components, for example ground blast-furnace slags, at ambient temperature. Cold quenching can also be carried out using an indirect tube cooler.

The invention also relates to a supersulphated cement obtained by the method according to the invention.

The stability and durability of this supersulphated cement have been studied. By evaluating the reaction progress at 28 days and 90 days by X-ray diffraction (XRD) and scanning electron microscope (SEM), it was possible to monitor the hydration of the interstitial solutions and the formation of calcium silicate hydrates (CSH). The reaction progress is optimum depending on the total consumption of calcium sulfate and that of calcium.

The reaction of the aluminosilicate, when properly activated, lasts until all the potential reactants, in particular gypsum and portlandite, have been consumed.

The consumption of calcium sulfates and calcium prevents alkali-aggregate reactions (AAR) and internal sulfate reactions (ISR) (delayed formation of ettringite).

Surprisingly, the cement according to the invention exhibits slow air rehydration kinetics, which gives the cement a storage stability in air four times longer than that of conventional cements.

Furthermore, there is a significant increase in the hydraulic and pozzolanic reactivities of the cement according to the invention. The mechanical performances of this cement are thus improved by 15% to 20% compared with conventional cements, in particular at young age, and a longer initial setting time as well as improved fluidities are also observed.

In view of these improved performances, the (K) component, clinker or cement can be eliminated. Eliminating this component from the mixture improves the carbon balance of the process used to produce the supersulphated cement, while retaining its minimum required performances.

These improved performances also allow the use of new aluminosilicate components, compared with the restricted list proposed in the standard, such as fly ashes, converter steelworks slags, volcanic slags, flashed metakaolins, papers mill ashes and their mixtures.

These pozzolanic industrial by-product components are thus recovered as raw materials.

Lastly, the energy consumed to produce cement is reduced by 35% to 45% compared with the energy required to produce a supersulphated cement according to the method described in document WO2015104466A1. This is possible due to the faster flash thermodynamic exchanges used to activate the components (Cs)+(K)+(A), firstly by recovering the thermal effluents resulting from the method, and secondly by recycling the hot fluid loaded with superheated steam resulting from dehydration of the calcium sulfate.

Thus, when producing the cement according to this invention, we observe an energy balance (mechanical energy and thermal energy) of less than 110 MJ/metric ton of cement, i.e. 10 times less than that of conventional cements.

FIG. 3 compares the CO₂ emissions (EmCO2) per metric ton of cement, for different types of cement, having different production methods, in particular the supersulphated cement (SSC) according to this invention, whose emission level is shown by the SSC bar on the abscissa.

The environmental balance (CO₂ energy+CO₂ material) of the cement according to this invention does not exceed 60 kg of CO₂, i.e. 12 times less than conventional cements.

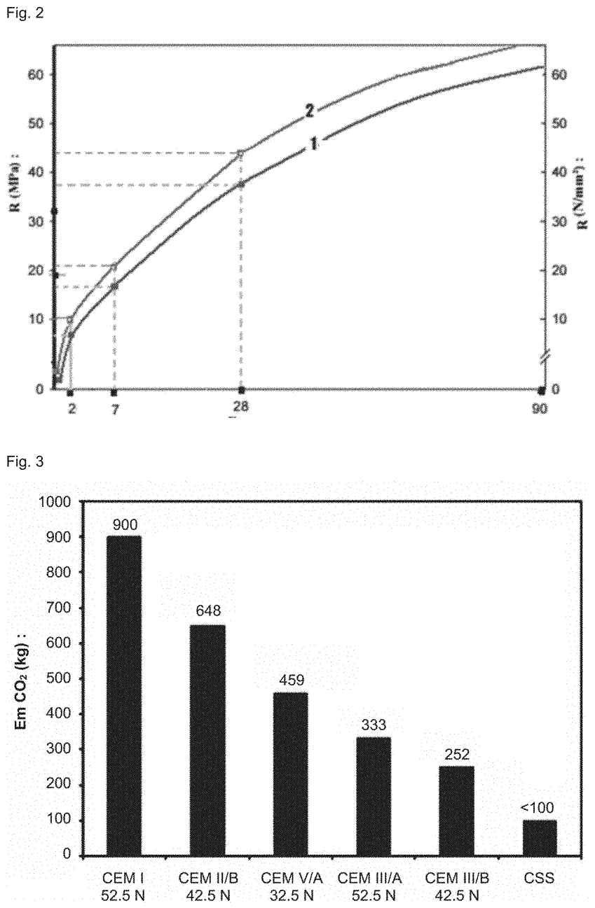

FIG. 2 shows the performance tests of the supersulphated cements carried out on mortars according to Standard NF EN 196-1. This figure can be used to compare the increase in strength (R) against the number of days hydration (E), firstly for supersulphated cements of the state of the art (curve 1) and, secondly for cements according to the invention produced using the method according to the invention (curve 2).

The results show that the mortar maturing conditions play a decisive role on the mechanical performances. Immersion cures can be carried out to achieve higher strength levels than under dry conditions with 90% humidity. The tests were carried out using standardized mortar (binder/sand mass ratio=1/3) with two mixing ratios (W/B=0.4 and 0.5) characteristic of the old and new standards concerning SSCs. Four conservation types were used: wet room, immersion at 20° C., immersion at 40° C. and ambient at 20° C. The shrinkage and weight variation measurements were monitored for 90 days. The mechanical performances were evaluated at 2, 7, 28, and 90 days. We observe that the strength of the supersulphated cements 32.5/42.5/52.5 changes significantly after 28 days. This effect is highly noticeable for the 0.40 mixing ratio. The compressive strengths continue to change after 90 days.

Fluidizing agents, plasticizers or superplasticizers, which can significantly reduce the amount of water, at constant workability window, and whose action, by reducing the porosity, significantly increases the mechanical performances of the final cement composition. Such water-reducing fluidizing agents, plasticizers or superplasticizers include the polycarboxylates and polymethacrylates® sold by the company COATEX® or RHEOBUILD® sold by the company BASF® or FLUID. sold by the company TILLMAN.

Preferably, the admixtures which can be used in the final formulation of the cement composition according to the invention can be selected from the admixtures described in standard NF EN 934-2. It should also be pointed out that the increased mechanical strengths conferred from a young age (4 hours after hydration) by the hydraulic cements according to the invention are not obtained at the expense of the workability window (or pot life) of the formulated cement compositions, which is satisfactory and guaranteed for at least 30 minutes, advantageously for a period of between 45 minutes and 90 minutes, at a temperature of between 5° C. and 30° C. According to this invention, the expression “workability window” means the time during which the slump of the formulated cement composition, evaluated according to standard EN 12350-2, remains greater than or equal to 10 mm.

The invention also relates to uses of the supersulphated cement obtained by the method according to the invention.

a) Production of low heat of hydration,

b) sea setting, sulfate-resistant and acid-resistant concretes and production of technical mortars.

c) Production of cellular concrete

The cement according to the invention is used in a method for producing cast or molded cellular concrete hardened under atmospheric pressure. To obtain such a concrete, the method comprises a step of mixing the cement according to the invention, mixing water, at least one surfactant, at least one fluidizing agent, and optionally at least one foaming agent.

According to one embodiment, a concrete of low density between 300 kg/m³ and 1000 kg/m³ offering a mechanical strength of up to 9 MPa, and a very low thermal conductivity of between 0.025 W/mK and 0.7 W/mK, preferably a thermal conductivity of less than 0.5 W/mK, is produced.

According to another embodiment, the cement according to this invention is used to prepare low-density materials such as light concretes, cellular concretes hardened under atmospheric pressure (called non-autoclave cellular concretes or foamed concretes), fire-resistant materials.

According to a preferred embodiment of the invention, a cellular concrete (hardened under atmospheric pressure) is prepared from the hydraulic cement according to this invention, by a method comprising the following steps:

a) mixing a cement according to this invention with at least one surfactant and at least one fluidizing agent;

b) adding the mixing water;

c) mixing the mixture obtained in step (b) to produce a mineral foam in which air bubbles are trapped;

d) casting the mineral foam thus obtained, in particular in a mold, and allowing it to harden.

Preferably, this method for producing cellular concretes hardened under atmospheric pressure further comprises prior to the mixing step (c), a step (b′) consisting in adding to the mixture obtained in step (b) one or more foaming agents or a foam produced separately using one or more foaming agents and water, it being possible to prepare said foam by any means for generating foam, known to those skilled in the art, for example by a compressed air foam generator or by a mechanical mixer. The foaming agent(s) are dosed at a rate of 1 liter to 1.5 liters per 2000 liters of water to produce a foam of apparent density 20 kg/m³ to 30 kg/m³. The dosage of foam to be incorporated in the mixture obtained in step (b) varies from 400 L/m³ to 800 L/m³ depending on the density of the desired concrete.

The foaming agents suitable for the implementation of this method are well known to those skilled in the art. We may mention in particular those proposed by the company PROVOTON® under the name Provoton® and by the company DR LUCAS&PARTNER® GmBH under the name Lithofoam®.

In practice, the water/hydraulic cement weight ratio is between 0.2 and 0.4, preferably between 0.25 and 0.35.

The quantity of surfactant(s) implemented in step (b) is preferably between 0.01 % and 0.5% w/w hydraulic cement, preferably 0.05% and 0.1% w/w hydraulic cement.

The addition of at least one surfactant favors the formation of foam and the stabilization of the fine bubbles created in the mineral foam during mixing. The surfactants suitable for the implementation of this method are well known to those skilled in the art. We may mention in particular those proposed by the company SIKA® in the range under the name powder AER®, or by the company CLARIANT® under the name OSTAPUR® OSB.

d) Production of a hydraulic road binder (HRB)

The cement according to the invention is used in a method for producing a hydraulic road binder (HRB) with normal or rapid hardening.

According to one embodiment, the hydraulic road binder comprises at least 50% supersulphated cement according to this invention, and at least 40% converter steelworks slags (CSS). The compressive strength Rc at 56 days on mortar (NF EN 196-1) was measured, and we obtain: 12.5 MPa≤Rc≤32.5 MPa.

e) Production of a calcium-sulfate-alkaline activator

The cement according to the invention is used in a method for producing a calcium-sulfate-alkaline activator to improve the performances of ordinary cements, concretes, technical mortars, slag cements, aluminous cements, sulfoaluminous cements and geotechnical or road binders, plasters, hydraulic or calcic limes, but not exclusively.

f) Production of eolian sand concrete

The cement according to the invention is used in a method for producing sand concrete based on aggregates of round eolian sands, or dune sand, eolian sands or ordinary sand. Such a cement can be used to produce structural reinforced concretes and mass concretes to build passive constructions with high thermal inertia.

The binders resulting from the method according to the invention exhibit hydraulic activation behavior in contact with the siliceous component aggregates in eolian sands. The mineral matrices thus formed consist of round sand grains whose surface is attacked by calcium-sulfate and alkaline activators.

This results in very high adhesion of the cement/aggregate interface.

The CSH gel coats the siliceous components perfectly, resulting in high strength equivalent to that obtained with concrete, quarry sand and gravel compositions. The spherical shape of the eolian aggregates improves the fluid rheology and reduces the quantity of mixing water.

According to one embodiment, a sand concrete is produced by mixing a cement according to the invention of density 350 kg/m³ with an eolian sand of size 0 to 2 mm and density 1950 kg/m³.

According to another embodiment, the eolian sand is replaced by ground pozzolan sand with:

Water dosage 182 liters;
0.4% of fluidizing agent ONS 2000 sold by Tillmann ®;
0.02% of Sika retarder P.

The compressive strength was studied. The following results were obtained:

at 24 hours: 12 MPa;
at 7 days: 29 MPa;
at 28 days: 59 MPa.

The flexural strength was studied. The following results were obtained:

at 24 hours: 4.2 MPa;
at 7 days: 9.7 MPa;
at 28 days: 13 MPa.

g) Production of mineralized aggregates

The cement according to the invention is used in a method for producing lightweight aggregates, thermal and acoustic insulation based on plant or wood waste or ground straw or other low-density waste, by mineralization of these components by means of a coating with quick-setting grout based on said cement.

According to one embodiment, plant aggregates are coated with a cement grout according to the invention. These plant aggregates based on flax shives, hemp particles or crushed wood are of major interest for the composition of lightweight concretes of density varying from 350 kg/m³ to 600 kg/m³. The length of the cut plant components is between 10 mm and 20 mm, preferably 15 mm.

In addition to their low density, these concretes made with these aggregates are particularly efficient in the production of acoustic absorbent materials, insulating materials, draining concretes, building renovation, insulating screeds, insulating walls, breeze blocks, noise walls, acoustic absorbent mortars, etc.

According to one embodiment, the method comprises the following steps:

phase A: preparing an SSC cement grout in a continuous high-speed double-shaft mixer in the presence of a fluidizing agent admixture, a hydraulic activator as described in this invention, composed of an All/All sulfate complex dosed at 10% of a sodium carbonate alkaline component and water of W/B ratio=0.50; mixing time 1 to 2 minutes;

phase B: injecting the grout in a high-speed double-shaft shoe mixer supplied in the upper part with plant aggregates; mixing time 2 to 4 minutes; at the outlet of the mixer, the plant aggregates are perfectly impregnated and mineralized; the adhesion of the mineralization on the plant aggregate is complete and its thickness is from 150 microns to 300 microns. These aggregates at the outlet of the mixer are then discharged onto a fluidized bed conveyor made of stainless-steel mesh crossed by a hot fluid at a temperature from 45° C. to 65° C. for 3 to 6 minutes; the grout setting time is adjusted between 5 to 8 minutes depending on the required production rate.

h) Waste recovery compositions

According to one embodiment, polyurethane waste or plastic waste or plant waste or wood waste is used.

At least one of the following compositions is made:

1) lightweight concrete and thermal insulation, composed of cement according to the invention with the addition of recycled aggregates.

2) technical mortar composed of cements according to the invention with the addition of the above-mentioned aggregates, or plastics.

3) aggregates for lightweight concretes composed of low-density and insulating cement according to the invention, by a method of mineralizing the above-mentioned aggregates for the production via a continuous mixer, of aggregates intended for concrete plants, prefabrication plants, road works, individuals and GSB.

4) insulating materials composed of cement according to the invention and the above-mentioned aggregates, by casting, molding, pressing, vibro-compacting of concretes.

5) ready-mix draining concrete composed of cement according to the invention and the above-mentioned aggregates for landscape applications, stabilization of slopes, soil drainage, and exterior decorative applications.

i) Production of thermally-activated concretes

The cement resulting from the method according to the invention can be used to produce thermally-activated concretes, formulated for intensive industrial prefabrication, with compressive strengths of 15 to 25 MPa in 8 hours.

Such concretes can comprise calibrated aggregates, calcareous or siliceous hydraulic fillers and alkaline agents such as sodium carbonate or calcium silicates.

j) Production of plaster components of very high Shore hardness

The cement resulting from the method according to the invention can be used to produce plaster components of very high Shore hardness implemented by molding, casting, injection, spraying, lamination.

k) Encapsulation of hazardous industrial waste

The cement resulting from the method according to the invention can be used to encapsulate hazardous industrial waste (chemical, pharmaceutical or radioactive), by coating these components in a stable and non-leachable mineral matrix.

l) Production of prefabricated composite elements

The cement resulting from the method according to the invention can be used to produce prefabricated composite elements based on wood and concrete, elements such as panels, sandwich panels, insulating panels, acoustic panels, slabs, preslabs, walls, but not exclusively.

The activation method according to this invention induces numerous transformations on the components of the activation complex and thus considerably increases their reactivity:

Instantaneous dehydration of the components.

Formation in a toroidal flash of variable cross-section, of composite phases of calcium sulfate comprising in the same particles: anhydrite II, anhydrite III and alpha sigma hemihydrate phases arranged concentrically;

The compositions thus obtained lead to:

up to 8% of “alpha sigma” hemihydrate phases arranged around the particles,

up to 92% of anhydrite III phases arranged at the center of the particles,

very few anhydrite II phases.

The raw material sources used to obtain said calcium sulfate phases include natural or synthetic gypsum dihydrates as well as hemihydrate plasters.

The main advantage of these composite calcium sulfate phases is their hypersolubility compared with the existing calcium sulfate phases in the state of the art.

As an indication, the solubility of the hemihydrate at 20° C. is 9 g·L⁻¹, that of gypsum is 2 g·L⁻¹, while that of the composite calcium sulfate according to this invention is greater than 15 g·L⁻¹.

This very high solubility index is the main factor allowing intense activation of the aluminosilicate components which induce the early formation of primary ettringite and that of the calcium silicate hydrates (CSH).

One of the characteristics of this calcium sulfate composite is its high stability in air due to its microencapsulation by stable hydrated phases which ultimately increase the kinetics of hydration and the chemical reactivities in aqueous medium.

These original composite sulfate phases are characteristic of this invention and their specific performances characterize the inventive step.

The intrinsic performances of this calcium sulfate composite are characterized by very high mechanical performances: CR at 12 hours greater than 30 MPa and CR at 7 days greater than 40 MPa.

Autogenous micronization of particles by “mechanical-synthetic” action occurring in the high-speed kinetic friction inside the angular ducts of the flash.

Increased specific surface areas of the particles up to 4500 Blaines.

Modification of the mesh parameters and micro structural crystalline modification of the calcium sulfate phases.

In addition, the flash thermodynamic treatment used by the method according to the invention causes the following parameters, which are programmed and controlled by the computerized management, to interact:

hot quenching and cold quenching temperatures;

circulation speeds and volumetric flow rates of the hot fluid;

atmospheric pressures upstream and downstream from the flash;

component feed rates;

initial humidity of the components.

These physicochemical modifications induce high performances during their hydration in the presence of aluminosilicate components (pozzolanic components):

increase in the kinetics of hydration at young and old age (strength factor);

increase in the physicochemical inter-reactivities of the calcium-aluminum-sulfate components;

increase in the dissolutions/precipitations of the siliceous components;

total consumption of the calcium sulfate components;

total consumption of Portlandite;

elimination of the risks of secondary ettringite, which causes pathologies;

majority formation of stable primary ettringites from the first hours of hydration;

formation of resistant calcium silicate hydrates (CSH) from 48 hours, increasing after 90 days,

elimination of swelling and shrinkage during hydration and setting;

elimination of the heat of hydration, which causes microcracking in mass concretes;

increase in the adhesion between the cement matrix and the aggregates;

increase in the stabilities in air of the SSCs (storage time increased by 300%);

significant increase in the interface adhesion between the cement matrix and the rebars;

wider choice of compatible aggregates (sea and eolian sands, sediments, plant components, wood, plastics, etc.);

dimensional stability of the concretes at high and low temperatures;

reduced porosities due to the “colonization” of the interstices by the calcium silicate hydrates (CSH);

resistance to acids, alkalis, sugars and sulfates;

resistance to bacteria in hydraulic media;

increased fire resistance compared with the OPCs (Portland);

rheologies adaptable to all types of application;

application open times adjustable as required from 20 minutes to 1 hour;

durable encapsulations of heavy metals;

substitution and replacement of alpha hemihydrate plasters in the case of technical mortar formulations;

the use of water-reducing superplasticizers allows a water-to-binder ratio of 0.40;

reducing the water-to binder-ratio to 0.35 results in an additional 15% strength increase;

kinetics of carbonation reduced by 50% compared with the OPC cements;

minimum porosities of 9%;

increased durabilities due to the low porosities and the stability of the hydrates thus composed.

1. A method for producing supersulfated cement comprising the following steps:
mixing together pozzolanic and hydraulic aluminosilicate components and a calcium-sulfate-alkaline activation complex,
wherein said calcium-sulfate-alkaline activation complex is produced by carrying out the following successive steps:
a first step of mixing 70% by weight of calcium sulfate and 30% by weight of alkaline components; and subsequently;
a second step of thermodynamically activating, by hot quenching, the calcium-sulfate-alkaline activation complex; and subsequently; and
a third step of cold quenching, by rapid mixing, the activated calcium-sulfate-alkaline activation complex with the pozzolanic aluminosilicate components.

2. The method according to claim 1, wherein the calcium sulfate is a composition with 5% to 10% by weight of soluble anhydrite II, 70% to 80% by weight of alpha anhydrite III, and 15% to 30% by weight of alpha hemihydrate.

3. The method according to claim 1, wherein the alkaline components are selected alone or in combination from the following components: synthetic or natural pozzolanic and hydraulic components, an amorphous calcium aluminate, hydraulic limes, calcic limes, quicklimes, basic components.

4. The method according to claim 1, wherein the pozzolanic and hydraulic aluminosilicate component comprises at least 75% by weight of natural or synthetic pozzolanic and hydraulic components.

5. The method according to claim 4, wherein the pozzolanic and hydraulic aluminosilicate components comprise a granulated blast-furnace slag.

6. The method according to claim 1, wherein at least 75% by weight of pozzolanic and hydraulic aluminosilicate components are mixed with a maximum of 20% by weight of the calcium-sulfate-alkaline activation complex.

7. The method according to claim 1, wherein the second step of activating said calcium-sulfate-alkaline activation complex comprises transforming and activating the calcium sulfate using a flash thermodynamic method.

8. The method according to claim 7, wherein the flash thermodynamic method is designed to homogenize, micronize, thermally shock said calcium sulfate, and transform it into phases with high hydraulic reactivities such as anhydrite II, alpha anhydrite III and alpha hemihydrate composite phases.

9. The method according to claim 8, wherein micronization is a kinetic autogenous micronization obtained by mechanosynthesis of particles.

10. The method according to claim 9, wherein the temperature of the components of the calcium-sulfate-alkaline activation complex is between 150° C. and 300° C. at the outlet of the flash thermodynamic method.

11. The method according to claim 7, wherein the flash thermodynamic method comprises a step of thermal shock carried out in a hot fluid of superheated steam.

12. The method according to claim 11, wherein the transformation of calcium sulfate is a transformation in complex phases carried out by a flash thermodynamic reactor comprising a toroidal duct and an electronic management unit.

13. The method according to claim 12, wherein the electronic management unit is designed to control the parameters of the thermal activation step.

14. The method according to claim 12, wherein a step of almost instantaneously dehydrating the components of the calcium-sulfate-alkaline activation complex is carried out by direct contact and by entrainment by a gaseous fluid loaded with superheated steam in the toroidal duct placed under reduced pressure at the outlet and subjected at the inlet to a pressure of between 50 mbar and 200 mbar, at a temperature set between 250° C. and 450° C., generating a flow of the incoming gaseous fluid at a speed of between 15 m/s and 25 m/s.

15. The method according to claim 14, wherein the hot fluid loaded with superheated steam is partially recycled and mixed with new air in an electro-regulated mixing chamber. Treatment under pressurized superheated steam characteristic of the alpha calcium sulfate phases.

16. The method according to claim 15, wherein the new air is heated by the hot fluid extracted in an air/air heat exchanger.

17. The method according to claim 16, wherein the fluid loaded with steam is heated by an automated burner and mixed in a combustion chamber before being injected into the flash thermodynamic reactor by a battery of injectors.

18. The method according to claim 17, wherein at the outlet of the flash thermodynamic reactor, the speed of the hot gaseous fluid is between 30 m/s and 50 m/s, the temperature is between 180° C. and 300° C.

19. The method according to claim 1, wherein the third step of cold quenching is carried out to cool the calcium-sulfate-alkaline activation complex to a temperature of between 30° C. and 50° C. in less than one minute.

20. The method according to claim 19, wherein the second step of activating said calcium-sulfate-alkaline activation complex comprises transforming and activating the calcium sulfate using a flash thermodynamic method, and the third step of cold quenching is carried out by rapidly mixing the activated calcium-sulfate-alkaline activation complex at the outlet of the flash thermodynamic method with the pulverulent pozzolanic aluminosilicate components at 30° C.+/−15° C. in a continuous mixer.

21. The method according to claim 19, wherein the second step of activating said calcium-sulfate-alkaline activation complex comprises transforming and activating the calcium sulfate using a flash thermodynamic method, and the third step of cold quenching is carried out by rapidly mixing the calcium-sulfate-alkaline activation complex at the outlet of the flash thermodynamic method with the pozzolanic aluminosilicate components, for example ground blast-furnace slags, at ambient temperature.

22. A supersulphated cement obtained by the method according to claim 1.

23. The supersulphated cement according to claim 22, wherein the cement is use:
in the production of low heat of hydration, sea setting, sulfate-resistant and acid-resistant concretes and in the production of technical mortars; or
in the production of cast or molded cellular concrete hardened under atmospheric pressure, comprising said cement, mixing water, at least one surfactant, at least one fluidizing agent, and optionally at least one foaming agent; or
in the composition of a hydraulic road binder (HRB) with normal or rapid hardening; or
in the production of a calcium-sulfate-alkaline activator to improve the performances of cements, concretes and mortars; or to improve the performances of cements, concretes, technical mortars, slag cements, aluminous cements, sulfoaluminous cements and geotechnical or road binders, plasters, hydraulic or calcic limes; or
for the production of sand concrete based on aggregates of round eolian sands, or dune sand, eolian sands or ordinary sand; or
for the production of lightweight aggregates, thermal and acoustic insulation based on plant or wood waste or ground straw or other low-density waste, by mineralization of these components by means of a coating with quick-setting grout based on said cement; or
for the production of thermally-activated concretes; or
for the production of plaster components of very high shore hardness implemented by molding, casting, injection, spraying, lamination; or
for the encapsulation of hazardous industrial waste by coating these components in a stable and non-leachable mineral matrix; or
for the production of prefabricated composite elements based on wood and concrete, elements such as panels, sandwich panels, insulating panels, acoustic panels, slabs, preslabs, walls.
